(19) United States
(12) Patent Application Publication
(10) Pub. No.: US 2002/0104417 A1
(43) Pub. Date: Aug. 8, 2002

(54) Quick press device for a table saw

(76) Inventor: Ruey-Zon Chen, Tali City (TW)

Correspondence Address: BACON & THOMAS, 625 Slaters Lane - 4th Floor, Alexandria, VA, 22314, US

(21) Appl. No.: 09/776,777

(22) Filed: Feb. 6, 2001

(51) Int. Cl. B26D 7/06; B27B 27/04

(52) U.S. Cl. 83/435.14; 83/437.2; 83/438; 83/477.2

(57) ABSTRACT

A quick press device for a table saw includes a handle connected to a miter gauge and a mediate member is pivotally connected to the other end of the handle. An arm pivotally received in the mediate member and a knob member is inserted into the arm. A spring is received in the arm and biases against the knob member. A shaft extends through the arm and the knob member wherein the hole in the knob member is larger than the hole of the arm. The shaft presses on the object when pushing the knob member to allow the shaft to be freely shifted in the hole of the knob member. The knob member is then released to be biased by the spring to securely position the shaft. A crank lifts an end of the arm to presses the shaft downward.

### FIELD OF THE INVENTION

The present invention relates to a quick press device connected with the blade gauge and the quick press device easily presses the object to be cut in position.

### BACKGROUND OF THE INVENTION

A conventional table saw generally includes a table and a circular saw blade rotatably extends from a top surface of the table so as to cut an object. A fence extends from an end of the top surface of the table so that an end of the object is moved along the fence to be moved toward the saw blade. However, in order to move the object in stable, the operator's hand has to press the object to make sure that the underside of the object is moved on the top surface of the table. Because the force of the operator's hand is not enough to firmly press the object so that the object could shank or shift during cutting process. Besides, the hand could be cut by the saw blade because it is moved toward the saw blade to send the object toward the saw blade.

### SUMMARY OF THE INVENTION

In accordance with one aspect of the present invention, there is provided a quick press device for table saws and comprising a handle fixedly connected to a miter gauge of the table saw and a second end of the handle is pivotally connected to a mediate member. The mediate member is connected to a top of the miter gauge. An arm has a first end thereof inserted into the mediate member and a second end of the arm extends from the mediate member. A mediate portion of the arm is pivotally connected to the mediate member and a spring is biased between a top of the arm and an inner side of the mediate member. A crank extends through the mediate member and is pivotally engaged with the first end of the arm. A recess is defined longitudinally in the second end of the arm and a knob member is movably received in the recess and biased by the spring. The knob member has a hole defined therethrough. A passage is defined through the second end of the arm and opens to the top and an underside of the arm. The passage communicates with the recess and the hole. The hole is larger than the passage. A shaft extends through the hole and the passage. A pressing member is pivotally connected to a lower end of the shaft.

The primary object of the present invention is to provide a quick press device which is easily to apply a force on the object and the device is connected to a miter gauge of the table saw so that the object can be cut in stable and the hand of the operator does not put close to the saw blade.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is a perspective view to show the quick press device of the present invention and a miter gauge on the table saw;

FIG. 2 is an exploded view to show the quick press device of the present invention;

FIG. 3 is a perspective view to show that the quick press device of the present invention is used on a table saw;

FIG. 4 is a cross sectional view to show that the shaft is not yet pressed on the object to be cut, and

FIG. 5 is a cross sectional view to show that the shaft is pressed on the object by rotating the crank.

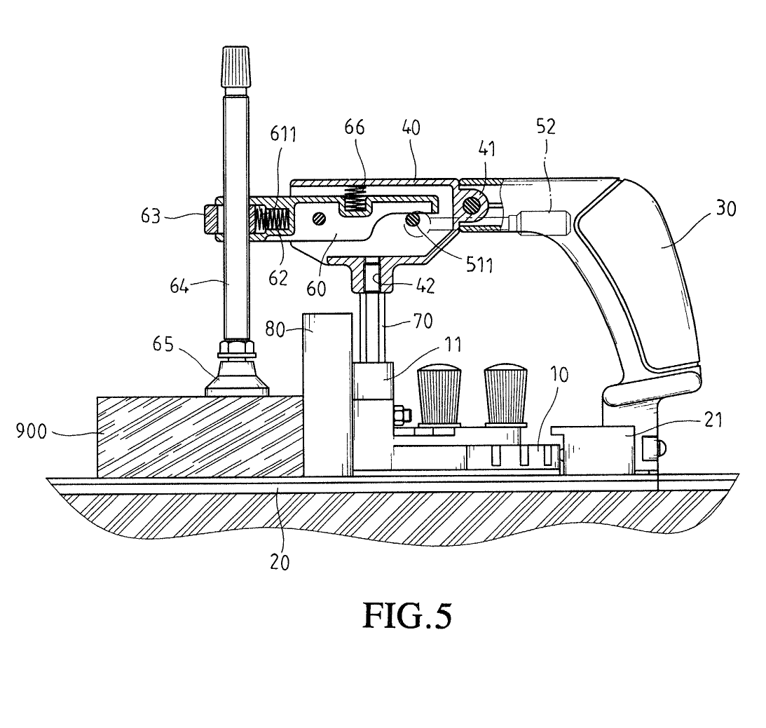

### DETAILED DESCRIPTION OF THE PREFERRED EMBODIMENT

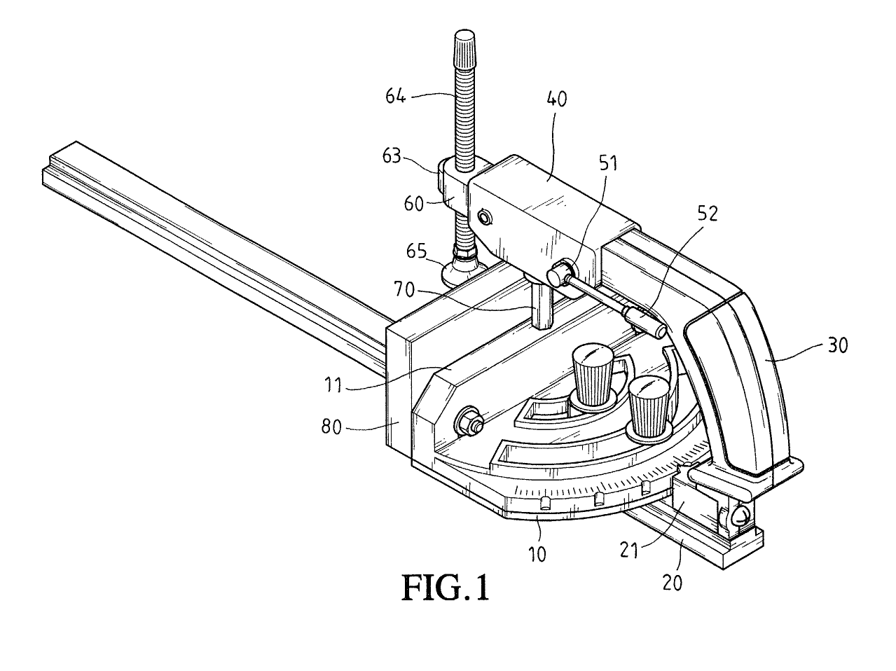

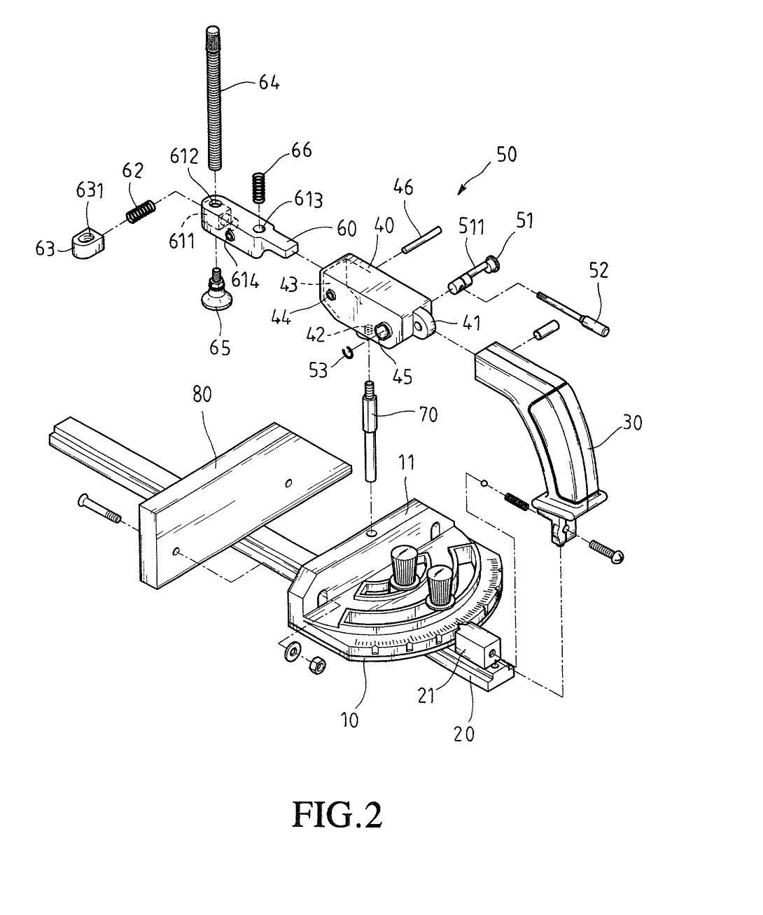

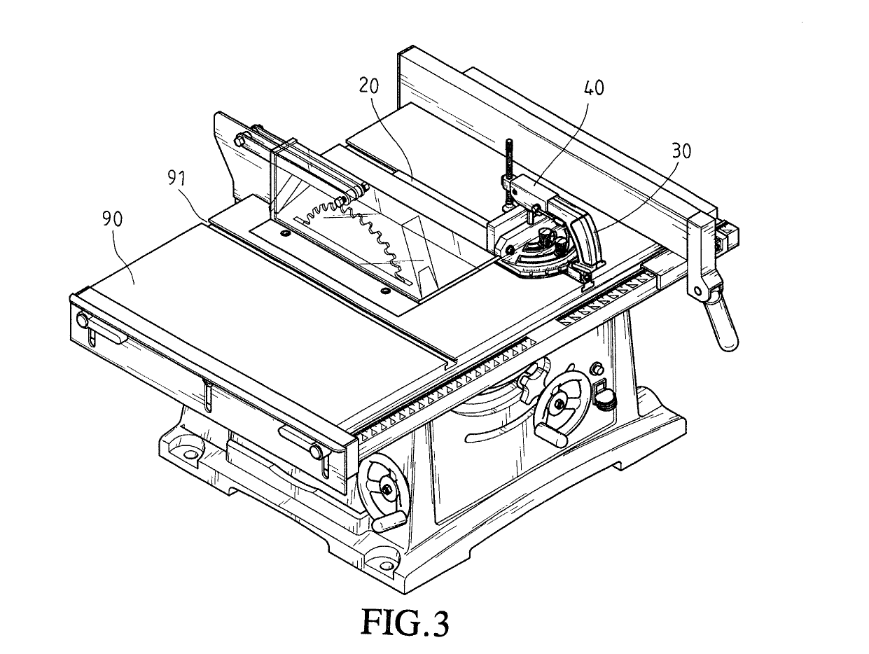

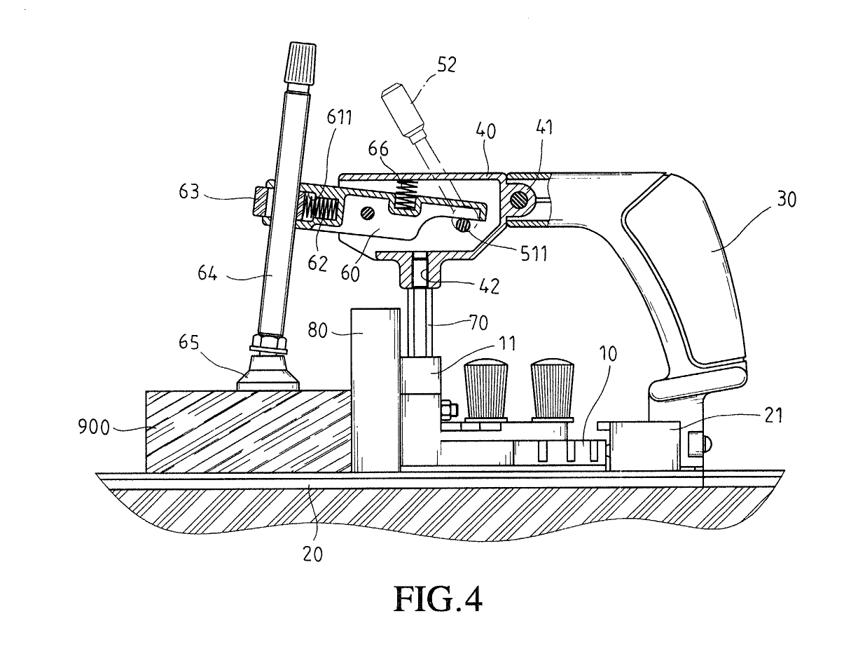

Referring to FIGS. 1 to 4, the quick press device of the present invention comprises a handle 30 having a first end fixedly connected to a mark member 21 on a miter gauge 10 which is movably connected to a rail 20 on the table saw. The rail 20 is received in one of two slots 91 in the top surface of the table 90. A second end of the handle 30 is pivotally connected to a lug 41 on a first end of a mediate member 40. A second end of the mediate member 40 has an open end 43 for receiving a first end of an arm 60 therein. An underside of the mediate member 40 has an engaging recess 42 and a rod 70 is received in the engaging recess 42. The other end of the rod 70 is fixedly connected to a top 11 of the miter gauge 10 so that the handle 30 is moved with the miter gauge 10.

A mediate portion of the arm 60 is pivotally connected to the mediate member 40 by extending a pin 46 through the holes 44 in the mediate member 40 and a hole 614 in the arm 60. The second end of the arm 60 extends from the open end 43 of the mediate member 40. A dent 613 is defined in a top of the arm 60 and an end of a spring 66 received in the dent 613, the other end of the spring 66 contacts an inner side of the mediate member 40. A crank 50 includes a rod 51 rotatably extending through holes 45 in the mediate member 40 and an end of the rod 51 is positioned by a C-shaped clamp 53 and a handle 52 is connected to the end of the rod 51. The rod 51 has an eccentric section 511 which contacts the first end of the arm 60. Therefore, the arm 60 is pivotable about the pin 46 and the spring 66 normally lowers the first end of the arm 60.

A recess 611 is defined longitudinally in the second end of the arm 60 and a knob member 63 is movably received in the recess 611. A spring 62 is biased between the knob member 63 and an inside of the recess 611. The knob member 63 has a hole 631 defined therethrough and the knob member 63 has a rounded end which extends from the recess 611 of the arm 60. A passage 612 is defined through the second end of the arm 60 and opens to the top and an underside of the arm 60. The passage 612 communicates with the recess 611 and the hole 631. An inner diameter of the hole 631 is larger than an inner diameter of the passage 612. A shaft 64 extends through the hole 631 and the passage 612, and the diameter of the shaft 64 is smaller than the hole 631. A pressing member 65 is pivotally connected to a lower end of the shaft 64.

A guide member 80 is connected to the miter gauge 10 so that an object 900 is put to contact the guide member 80 and moved toward the saw blade. When pressing the object 900, the rounded end of the knob member 63 is pushed and because the hole 631 is larger than the diameter of the shaft 64, the shaft 64 drops and the pressing member 65 contacts the object 900. The knob member 63 is then released and the knob member 63 is pushed by the spring 62 and the shaft 64 is pushed to contact against the inner periphery of the passage 612. The handle 52 is then rotated to lift the first end of the arm 60 and the shaft 64 then presses the object 900. The operator simply holds the handle 30 to move the object 900 which is pressed by the shaft 64. The object 900 is easily to be pressed simply by pushing the knob member 63 and rotating the handle 52 of the crank 50.

While we have shown and described various embodiments in accordance with the present invention, it should be clear to those skilled in the art that further embodiments may be made without departing from the scope and spirit of the present invention.

What is claimed is:

1. A quick press device for table saws which have a miter gauge located on a top surface of the table and the miter gauge is moved along a rail, the quick press device comprising:
a handle having a first end adapted to be fixedly connected to the miter gauge and a second end of said handle pivotally connected to a mediate member, said mediate member adapted to be connected to a top of said miter gauge by a rod;
an arm having a first end thereof inserted into said mediate member and a second end of said arm extending from said mediate member, a mediate portion of said arm pivotally connected to said mediate member and a spring biased between a top of said arm and an inner side of said mediate member, a crank extending through said mediate member and pivotally engaged with said first end of said arm, a recess defined longitudinally in said second end of said arm and a knob member movably received in said recess, a spring biased between said knob member and an inner periphery of said recess, said knob member having a hole defined therethrough, a passage defined through said second end of said arm and opening to said top and an underside of said arm, said passage communicating with said recess and said hole, an inner diameter of said hole being larger than an inner diameter of said passage, and
a shaft extending through said hole and said passage, a pressing member pivotally connected to a lower end of said shaft.

2. The device as claimed in claim 1 further comprising a dent defined in said top of said arm and an end of said spring received in said dent.

3. The device as claimed in claim 1, wherein said crank includes a rod rotatably extending through said mediate member and having an eccentric section which contacts said first end of said arm.

4. The device as claimed in claim 1 wherein said knob member comprising a rounded end which extends from said recess 611 of said arm.
